(19) United States
(12) Patent Application Publication
(10) Pub. No.: US 2026/0281599 A1
(43) Pub. Date: Sep. 17, 2026

(54) Earphone Detection

(71) Applicant: Anker Innovation Technology Co., Ltd, Changsha (CN)

(72) Inventor: Chunsheng Zheng, Shenzhen (CN)

(21) Appl. No.: 19/564,479

(22) Filed: Mar. 12, 2026

(30) Foreign Application Priority Data
Mar. 14, 2025 (CN) 202510307744.6

(51) Int. Cl. H04R 1/10; H04R 29/00

(52) U.S. Cl. CPC H04R 1/1016; H04R 29/00

(57) ABSTRACT

A wearing state of an earphone can be detected. A method comprises: determining that the earphone meets an in-ear condition based on a capacitance value of a capacitive sensor in the earphone when the earphone is in an initial wearing stage and determining a wearing matching degree result of the earphone based on the capacitance value of the capacitive sensor when the earphone is in a second wearing stage. The method further comprises obtaining sealing information in response to the wearing matching degree result being mismatched. The sealing information indicates a sealing state of an in-ear part of the earphone. The method further comprises determining a current state of the earphone based on the sealing information.

### CROSS-REFERENCE TO RELATED APPLICATION

The present application claims priority to Chinese Patent Application No. 202510307744.6, filed on March 14, 2025, which is incorporated herein by reference in its entirety.

### FIELD

The present disclosure relates to the technical field of earphones, particularly to a method for detecting a wearing state of an earphone, an earphone, and a storage medium.

### BACKGROUND

In the related art, many earphones have added a state detection function for determining whether the earphone is in an in-ear state. Currently, a capacitive sensor is typically adopted to detect the in-ear state of the earphone.

When a capacitive sensor is adopted to detect the wearing state of the earphone, a detection principle of the capacitive sensor uses the capacitive sensor to detect a capacitance change. When a human skin approaches or contacts the capacitive sensor, a capacitance value changes, and whether the earphone is worn in an ear is determined by detecting the change. But because the capacitance value of the capacitive sensor is directly related to an area of a human ear skin contacting a detection area of the capacitive sensor (e.g., the larger the contact area of the skin is, the larger the capacitance value is), ear contours and shapes, and wearing angles of different people (including differences in gender, age, and the like) are quite different, and areas of the ear skin contacting the detection area of the capacitive sensor are also quite different when different people wear the earphone, thereby leading to low accuracy of detecting the wearing state through the capacitive sensor.

### SUMMARY

In view of this, in order to solve the technical problem of low accuracy of the wearing detection in the related art, the present disclosure provides a method for detecting a wearing state of an earphone, an earphone, and a storage medium.

In a first aspect, an example of the disclosure provides a method for detecting a wearing state of an earphone including a capacitive sensor. A method comprises: determining that the earphone meets an in-ear condition based on a capacitance value of a capacitive sensor in the earphone when the earphone is in an initial wearing stage and determining a wearing matching degree result of the earphone based on the capacitance value of the capacitive sensor when the earphone is in a second wearing stage (e.g., a stable wearing stage). The method further comprises obtaining sealing information in response to the wearing matching degree result being mismatched. The sealing information indicates a sealing state of an in-ear part of the earphone. The method further comprises determining a current state of the earphone based on the sealing information.

In a possible implementation mode, determining that the earphone meets an in-ear condition based on a capacitance value of the capacitive sensor when the earphone is in an initial wearing stage includes: when the earphone is in an initial wearing stage, if each of a plurality of continuous capacitance values greater than a first in-ear threshold are detected, determining that the earphone meets the in-ear condition.

In a possible implementation mode, determining a wearing matching degree result of the earphone based on the capacitance value of the capacitive sensor when the earphone is in a stable wearing stage includes: in a stable wearing stage, if it is detected that the capacitance value is less than or equal to a third in-ear threshold and greater than a second in-ear threshold, determining that the wearing matching degree result of the earphone is mismatched, where the third in-ear threshold is greater than the second in-ear threshold and less than the first in-ear threshold.

In a possible implementation mode, after determining the current state of the earphone, the method further comprises: determining that the earphone meets an out-of-ear condition based on the capacitance value; obtaining the wearing matching degree result of the earphone in the second wearing stage; if the wearing matching degree result is mismatched, obtaining pose information of the earphone and second sealing information of the in-ear part, where the pose information indicates the position and/or attitude of the earphone, and the second sealing information indicates the sealing state of the in-ear part; and determining whether the current actual state of the earphone is the out-of-ear state based on the pose information and the second sealing information.

In a possible implementation mode, determining that the earphone meets an out-of-ear condition based on the capacitance value includes: based on detecting each of a plurality of continuous capacitance values being less than an out-of-ear threshold, determining that the earphone meets the out-of-ear condition; based on not detecting each of a plurality of continuous capacitance values being less than an out-of-ear threshold, determining that the earphone does not meet the out-of-ear condition.

In a possible implementation mode, determining the current state of the earphone is an in-ear state based on the sealing information includes: based on determining that the earphone is in a preset pose based on the pose information, and based on determining that the in-ear part is in the sealing state based on the sealing information, determining that the current state of the earphone is the in-ear state; based on determining that the earphone is not in the preset pose based on the pose information, or based on determining that the in-ear part is in a leaking state based on the sealing information, determining that the current state of the earphone is the out-of-ear state.

In a possible implementation mode, the earphone includes an acceleration transducer used for determining a pose of the earphone; and/or the earphone includes an infrasound sensor used for determining the sealing information.

In a possible implementation mode, a first start time of the infrasound sensor is later than a second start time of the acceleration transducer; the first start time indicates a start time when the infrasound sensor collects a signal for determining the sealing information; and the second start time indicates a start time when the acceleration transducer collects a signal for determining the pose.

In a second aspect, an example of the disclosure provides an earphone includes: a memory configured to store a computer program; and a processor configured to execute the computer program stored in the memory, and implement the method for detecting a wearing state of an earphone according to any one implementation mode of described herein when the computer program is executed.

In a third aspect, an example of the disclosure provides a non-transitory computer-readable storage medium on which a computer program is stored. When executed by a processor, the computer program implements the method for detecting a wearing state of an earphone according to any one implementation mode described herein.

In an example, a method for detecting a wearing state of an earphone provided by the disclosure comprises: determining that the earphone meets an in-ear condition based on a capacitance value of the capacitive sensor when the earphone is in an initial wearing stage; determining a wearing matching degree result of the earphone based on the capacitance value of the capacitive sensor when the earphone is in a second (e.g., stable) wearing stage; obtaining pose information of the earphone and sealing information in response to the wearing matching degree result being mismatched, wherein the first pose information indicates a position and/or attitude of the earphone, and the first sealing information indicates a sealing state of an in-ear part of the earphone; and determining whether a current actual state of the earphone is an in-ear state based on the pose information and the sealing information.

When the earphone in the initial wearing stage meets the in-ear condition, the wearing matching degree result of the earphone in the stable wearing stage may be further determined. Further, when the wearing matching degree result is mismatched, whether the current actual state of the earphone is the in-ear state is determined based on the pose information of the earphone and the sealing information of the in-ear part. Thus, the accuracy of detecting whether the current actual state of the earphone is the in-ear state may be improved.

### BRIEF DESCRIPTION OF THE DRAWINGS

Accompanying drawings, which are incorporated in and constitute a part of this specification, illustrate examples according to the disclosure, which together with the specification serve to explain principles of the disclosure.

In order to more clearly illustrate the disclosure or technical solutions in the related art, the drawings that need to be used in description of the examples or the related art are briefly introduced below, and it is apparent to those of ordinary skill in the art that other drawings can be obtained based on these drawings without inventive work.

One or more examples are illustrated by the corresponding drawings, which does not constitute a limitation of the examples. Elements with the same reference numerals in the drawings represent similar elements, and the drawings do not constitute a scale limitation unless otherwise specified.

FIG. 1 illustrates a flowchart of a method for detecting a wearing state of an earphone provided by an example of the present disclosure;

FIG. 2 illustrates a flowchart of another method for detecting a wearing state of an earphone provided by an example of the present disclosure;

FIG. 3 illustrates a hardware system block diagram of an earphone provided by an example of the present disclosure;

FIG. 4A illustrates a diagram of parameters of an acceleration transducer in an earphone provided by an example of the present disclosure;

FIG. 4B illustrates a diagram of parameters for an acceleration transducer when an earphone is in a wearing process provided by an example of the present disclosure; and

FIG. 5 illustrates a structural diagram of an earphone provided by an example of the present disclosure.

### DETAILED DESCRIPTION

Various examples of the present disclosure will now be described in detail with reference to the accompanying drawings. Obviously, the described examples are part, but not all, of the examples of the present disclosure. It should be noted that relative arrangement, numerical expressions and numerical values of components and operations set forth in these examples do not limit a scope of the disclosure, unless otherwise specified.

Those skilled in the art can understand that terms such as "first" and "second" in the present disclosure are only used to distinguish objects such as different steps, devices, or modules, and neither represent any specific technical meaning nor the logical order between them.

It should also be understood that in the present example, "a plurality" may refer to two or more, and "at least one" may refer to one, two or more. It should also be understood that any component, data, or structure mentioned in the present disclosure can be generally understood as one or more unless explicitly defined or otherwise indicated in the foregoing and hereinafter.

In addition, “and/or” only describes an associating relationship between associated objects and indicates that there may be three relationships. For example, A and/or B, which may mean: three cases of A alone, A and B at the same time, and B alone. The character “/” generally indicates that the former and latter associated objects are in an “or” relationship. It should also be understood that the description of the present disclosure strongly emphasizes differences between the examples, and the same or similar parts thereof may refer to each other and will not be repeated for brevity.

The following description is merely illustrative actually and is in no way intended to limit the present disclosure and application or use thereof. Techniques, methods, and devices known to those of ordinary skill in the related art may not be discussed in detail, but should be regarded as part of the specification where appropriate. It should be noted that: like reference numerals and letters refer to like items in the following drawings, and therefore, once an item is defined in a drawing, it is not necessary to further discuss the item in the subsequent drawings.

It is to be noted that the examples and features in the present disclosure may be combined with each other in the case of no conflict. To facilitate the understanding of the disclosure, the present disclosure will be described in detail below with reference to the drawings and in conjunction with the examples. It is apparent that the described examples are part but not all of the examples of the present disclosure. Based on the examples of the disclosure, all other examples obtained by those of ordinary skill in the art without inventive work shall fall within the scope of the disclosure.

In order to solve the technical problem of how to improve the accuracy of determining whether a current actual state of the earphone is an in-ear state in the related art, the present disclosure provides a method for detecting a wearing state of an earphone, an earphone, and a storage medium, which may improve the accuracy of detecting whether the current actual state of the earphone is the in-ear state.

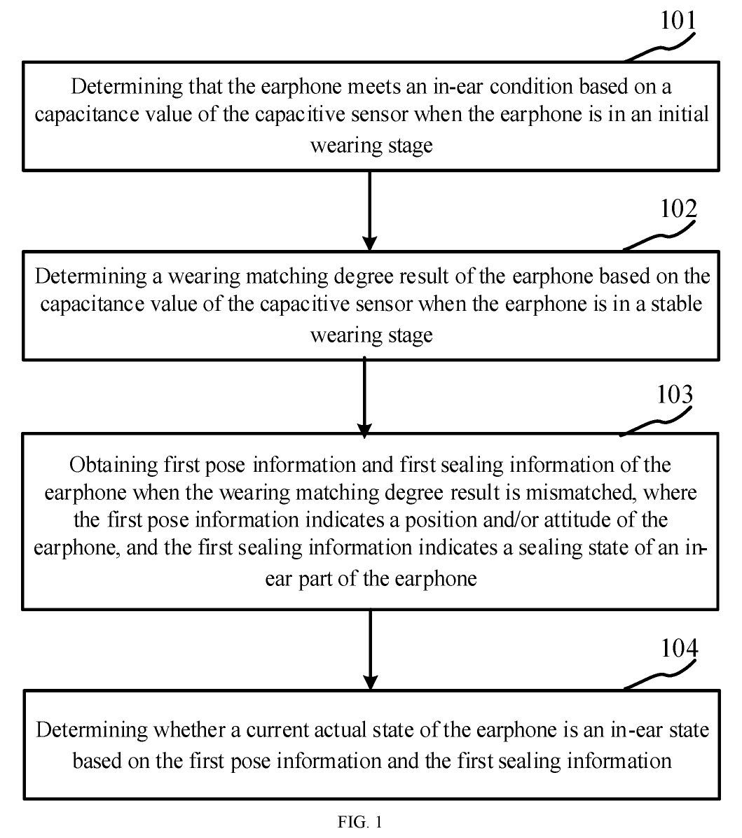

FIG. 1 illustrates a flowchart of a method for detecting a wearing state of an earphone provided by an example of the present disclosure. The method may be applied to one or more electronic devices such as earphones (for example, true wireless stereo earphones), smart phones, notebook computers, desktop computers, portable computers and servers. In addition, an execution subject of the method can be hardware or software. When the execution subject is the hardware, the execution subject may be one or more of the electronic devices described above. For example, a single electronic device may perform the method, or a plurality of electronic devices may perform the method in cooperation with each other. When the execution subject is the software, the method may be implemented as multiple software or software modules, or as a single software or software module, which is not specifically limited here.

The earphone includes a capacitive sensor. As shown in FIG. 1, the method comprises Step 101 to Step 104.

Step 101: determining that the earphone meets an in-ear condition based on a capacitance value of the capacitive sensor when the earphone is in an initial wearing stage.

In the example, the initial wearing stage may be an initial stage in which an object such as a user wears the earphone. Typically, when the earphone is in the initial wearing stage, compared to when the earphone is not worn, the capacitance value of the capacitive sensor increases to a relatively large value. Thereafter, when the earphone is in a stable wearing stage, the capacitance value of the capacitive sensor may tend to be stable (e.g., lower).

Step 102: determining a wearing matching degree result of the earphone based on the capacitance value of the capacitive sensor when the earphone is in a stable wearing stage (e.g., a second wearing stage).

In the example, the wearing matching degree result may indicate a matching degree of wearing the earphone by the object such as the user. For example, the wearing matching degree result may be matched, mismatched, etc. Here, multiple manners may be adopted to determine the wearing matching degree result of the earphone based on the capacitance value of the capacitive sensor.

As an example, the wearing matching degree result of the earphone may be determined by comparing the capacitance value of the capacitive sensor and an adjustment threshold (for example, a third in-ear threshold). For example, if the capacitance value of the capacitive sensor is greater than a preset threshold, it can be determined that the wearing matching degree of the earphone is high (e.g., matched). If the capacitance value of the capacitive sensor is less than or equal to the adjustment threshold, it can be determined that the wearing matching degree of the earphone is low (e.g., mismatched). As another example, the wearing matching degree result of the earphone may also be determined by determining a duration for which the capacitance value of the capacitive sensor is within a preset threshold range.

Step 103: obtaining first pose information of the earphone and first sealing information when the wearing matching degree result is mismatched. For example, the first pose information indicates a position and/or an attitude of the earphone, and the first sealing information indicates a sealing state of an in-ear part of the earphone. In an example, the first pose information may include a direction and an angle of the earphone. As an example, the first pose information of the earphone may be determined through at least one of an acceleration transducer, a gyroscope, or a Hall sensor.

The first sealing information may indicate that the in-ear part is in the sealing state, or is not in the sealing state (e.g., in a leaking state). The first sealing information of the in-ear part may be determined through at least one of an ultrasonic sensor, an air pressure sensor, a photoelectric sensor, or an infrasound sensor.

Step 104: determining whether a current actual state of the earphone is an in-ear state based on the first pose information and the first sealing information.

In the example, the current actual state may indicate an actual state of the earphone currently. Multiple manners may be adopted to determine whether the current actual state of the earphone is the in-ear state based on the first pose information and the first sealing information. As an example, if the first pose information indicates that the earphone is in the in-ear state, and the first sealing information indicates that the earphone is in the in-ear state, it can be determined that the current actual state of the earphone is the in-ear state. As another example, if the first pose information does not indicate that the earphone is in the in-ear state, or the first sealing information does not indicate that the earphone is in the in-ear state, it can be determined that the current actual state of the earphone is not the in-ear state, that is, it can be determined that the current actual state of the earphone is an out-of-ear state.

In some implementation modes of the example, it may be determined that the earphone meets the in-ear condition based on the capacitance value of the capacitive sensor when the earphone is in the initial wearing stage in the following manner: if several (for example, a preset positive integer of) continuous capacitance values greater than a first in-ear threshold are detected, determining that the earphone meets the in-ear condition. The capacitive sensor may detect the capacitance value in real time or periodically. The first in-ear threshold may be a capacitance value that is predetermined and indicates that the earphone is in the initial wearing stage.

In the above implementation modes, whether the earphone meets the in-ear condition may be determined by judging whether there are several continuous capacitance values greater than the first in-ear threshold. Thus, misjudgment of the in-ear state caused by a sudden change or instability of the capacitance value may be reduced or even avoided.

In some implementation modes of the example, when the earphone is in the stable wearing stage, the wearing matching degree result of the earphone may be determined based on the capacitance value of the capacitive sensor in the following manner: if it is detected that the capacitance value is less than or equal to a third in-ear threshold and greater than a second in-ear threshold, determining that the wearing matching degree result of the earphone is mismatched. Specifically, the third in-ear threshold is greater than the second in-ear threshold and less than the first in-ear threshold. The second in-ear threshold may be a capacitance value that is predetermined and indicates that the earphone is in the stable wearing stage. The third in-ear threshold may be a value between the first in-ear threshold and the second in-ear threshold.

In the above implementation modes, whether the earphone is mismatched may be determined by judging a magnitude relationship between the capacitance value and the third in-ear threshold as well as the second in-ear threshold when the earphone is in the stable wearing stage. Thus, accuracy of determining the wearing matching degree result may be improved.

In the stable wearing stage, if it is detected that the capacitance value is greater than the third in-ear threshold, it can be determined that the wearing matching degree result of the earphone is matched.

In some implementation modes of the example, whether the current actual state of the earphone is the in-ear state may be determined based on the first pose information and the first sealing information in the following manner: if it is determined that the earphone is in a preset pose based on the first pose information, and it is determined that the in-ear part is in the sealing state based on the first sealing information, determining that the current actual state of the earphone is the in-ear state; if it is determined that the earphone is not in the preset pose based on the first pose information, or it is determined that the in-ear part is in the leaking state based on the first sealing information, determining that the current actual state of the earphone is the out-of-ear state.

In the above implementation modes, the current actual state of the earphone is determined to be the in-ear state only when the earphone is in the preset pose and the in-ear part is in the sealing state. Thus, accuracy of the in-ear state detection may be improved.

In some implementation modes of the example, the earphone includes an acceleration transducer used for determining the pose information. Additionally or alternatively, the earphone includes an infrasound sensor used for determining the sealing information.

In the above implementation modes, the pose information may be determined more timely, accurately, and stably through the acceleration transducer. Thus, accuracy of the earphone state detection may be improved. In addition, since ultrasonic waves have a high frequency and a short wavelength, and strong penetration ability during propagation, reflected energy received by a microphone is small when the earphone is worn on an ear. Moreover, limited by device performance, after 15 kHz, an output amplitude of a speaker decreases rapidly. Thus, in the above implementation modes, whether the in-ear part is in the sealing state is detected through the infrasound sensor, which may improve the accuracy of the earphone state detection.

In some implementation modes of the example, when the earphone includes the acceleration transducer and the infrasound sensor, a first start time of the infrasound sensor is later than a second start time of the acceleration transducer.

For example, the first start time indicates a start time when the infrasound sensor collects a signal for determining the first sealing information. The second start time indicates a start time when the acceleration transducer collects a signal for determining the first pose information. The infrasound sensor may include the microphone and a loudspeaker of the earphone.

Since the microphone in the earphone may emit infrasound and the loudspeaker receive the infrasound during an enabling process of the infrasound sensor, the earphone cannot emit audible audio during the enabling process of the infrasound sensor. Therefore, in the above application scenario, by preferentially enabling the acceleration transducer and then enabling the infrasound sensor, impact of the earphone state detection on use of the earphone by the user may be reduced.

It should be noted that, the technical features described in different implementation modes may be included in the same example in the case of no conflict, and no further details are described herein for conciseness of description.

The method for detecting a wearing state of an earphone provided by an example of the present disclosure includes: determining that the earphone meets an in-ear condition based on a capacitance value of the capacitive sensor when the earphone is in an initial wearing stage; determining a wearing matching degree result of the earphone based on the capacitance value of the capacitive sensor when the earphone is in a stable wearing stage; obtaining first pose information of the earphone and first sealing information when the wearing matching degree result is mismatched, where the first pose information indicates a position and/or attitude of the earphone, and the first sealing information indicates a sealing state of an in-ear part of the earphone; and determining whether a current actual state of the earphone is an in-ear state based on the first pose information and the first sealing information. When the earphone in the initial wearing stage meets the in-ear condition, the wearing matching degree result of the earphone in the stable wearing stage may be further determined. Further, when the wearing matching degree result is mismatched, whether the current actual state of the earphone is the in-ear state is determined based on the first pose information of the earphone and the first sealing information of the in-ear part. Thus, the accuracy of detecting whether the current actual state of the earphone is the in-ear state may be improved.

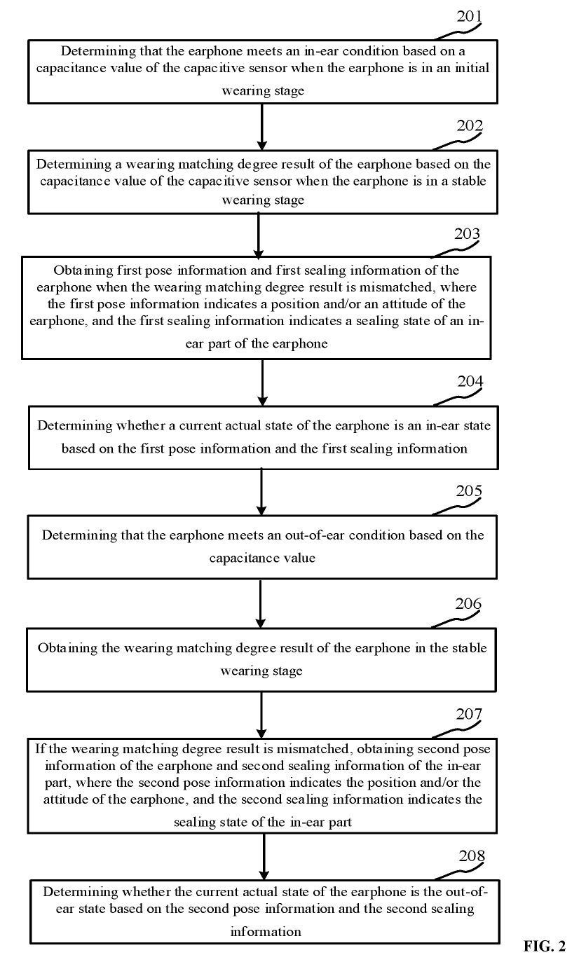

FIG. 2 illustrates a flowchart of another method for detecting a wearing state of an earphone provided by an example of the present disclosure. The earphone includes an acceleration transducer. As shown in FIG. 2, the method comprises:

Step 201: determining that the earphone meets an in-ear condition based on a capacitance value of the capacitive sensor when the earphone is in an initial wearing stage.

In the example, Step 201 is substantially consistent with or the same as Step 101 in the example corresponding to FIG. 1, and details thereof are not described herein again.

Step 202: determining a wearing matching degree result of the earphone based on the capacitance value of the capacitive sensor when the earphone is in a stable wearing stage.

In the example, Step 202 is substantially consistent with or the same as Step 102 in the example corresponding to FIG. 1, and details thereof are not described herein again.

Step 203: obtaining first pose information of the earphone and first sealing information when the wearing matching degree result is mismatched. Specifically, the first pose information indicates a position and/or an attitude of the earphone, and the first sealing information indicates a sealing state of an in-ear part of the earphone.

In the example, Step 203 is substantially consistent with or the same as Step 103 in the example corresponding to FIG. 1, and details thereof are not described herein again.

Step 204: determining whether a current actual state of the earphone is an in-ear state based on the first pose information and the first sealing information.

In the example, the current actual state may indicate an actual state of the earphone currently. Multiple manners may be adopted to determine whether the current actual state of the earphone is the in-ear state based on the first pose information and the first sealing information. As an example, if the first pose information indicates that the earphone is in the in-ear state, and the first sealing information indicates that the earphone is in the in-ear state, it can be determined that the current actual state of the earphone is the in-ear state.

Step 205: determining that the earphone meets an out-of-ear condition based on the capacitance value.

In the example, the out-of-ear condition may be used for preliminarily determining whether the earphone is in the out-of-ear state. As an example, the out-of-ear condition may include: there are several continuous capacitance values less than an out-of-ear threshold. Alternatively, the out-of-ear condition may also include: there are several capacitance values less than the out-of-ear threshold. The out-of-ear threshold may be a capacitance value that is predetermined and indicates that the earphone is in the out-of-ear state. The out-of-ear threshold may be less than the second in-ear threshold.

In some implementation modes of the example, determining that the earphone meets the out-of-ear condition based on the capacitance value may be implemented in the following manner: based on determining that each of a plurality of continuous capacitance values is less than the out-of-ear threshold, determining that the earphone meets the out-of-ear condition. In the above implementation modes, it may be determined more accurately that the earphone meets the out-of-ear condition since there are several continuous capacitance values less than the out-of-ear threshold.

Step 206: obtaining the wearing matching degree result of the earphone in the stable wearing stage.

In the example, in each wearing process (that is, a process from putting on the earphone to taking off the earphone by the user), the execution subject may record the wearing matching degree result of the earphone in the current stable wearing stage.

Step 207: if the wearing matching degree result is mismatched, obtaining second pose information of the earphone and second sealing information of the in-ear part. Specifically, the second pose information indicates the position and/or the attitude of the earphone, and the second sealing information indicates the sealing state of the in-ear part.

In the example, the second pose information may include a direction and an angle of the earphone. As an example, the second pose information of the earphone may be determined through at least one of an acceleration transducer, a gyroscope, or a Hall sensor.

The second sealing information may indicate that the in-ear part is in the sealing state or is not in the sealing state. The second sealing information of the in-ear part may be determined through at least one of an ultrasonic sensor, an air pressure sensor, a photoelectric sensor, or an infrasound sensor.

Step 208: determining whether the current actual state of the earphone is the out-of-ear state based on the second pose information and the second sealing information.

In the example, the current actual state may indicate an actual state of the earphone currently. Multiple manners may be adopted to determine whether the current actual state of the earphone is the out-of-ear state based on the second pose information and the second sealing information. As an example, if the second pose information indicates that the earphone is in the out-of-ear state, and the second sealing information indicates that the earphone is in the out-of-ear state, it can be determined that the current actual state of the earphone is the out-of-ear state.

As another example, if the second pose information does not indicate that the earphone is in the out-of-ear state, or the second sealing information does not indicate that the earphone is in the out-of-ear state, it can be determined that the current actual state of the earphone is not the out-of-ear state, that is, it can be determined that the current actual state of the earphone is an in-ear state.

It should be noted that, in addition to the foregoing content, this example may further include the corresponding technical features described in the example corresponding to FIG. 1, so as to achieve the technical effect of the method for detecting a wearing state of an earphone as shown in FIG. 1, which refers to the relevant description of FIG. 1 for details and is not repeated here for brevity.

According to the method for detecting a wearing state of an earphone provided by the example of the present disclosure, when the wearing matching result of the earphone in the stable wearing stage is mismatched, whether the current actual state of the earphone is the out-of-ear state is determined based on the second pose information of the earphone and the second sealing information of the in-ear part. Thus, the accuracy of detecting whether the current actual state of the earphone is the out-of-ear state may be improved.

The examples of the present disclosure will be exemplarily described below, but it should be noted that the following contents are merely used for understanding the technical solutions of the examples of the present disclosure, and do not limit the scope of protection of the examples of the present disclosure.

Before introducing the present scheme, technical terms involved in the scheme are introduced as follows:

Cap-sensor: a sensor based on a capacitive principle which may detect a distance and a position between an object and the sensor;

G Sensor: an acceleration transducer, also known as a gravity sensor, is an electronic device capable of measuring acceleration, detecting a tilt angle and a direction of the device is implemented by measuring components of gravitational acceleration on three axes of the device; and

TWS: a TWS earphone that is a True Wireless Stereo earphone.

Currently, many TWS earphones on the market have added a wearing detection function, and many of them adopt a Cap-sensor (capacitive sensor) scheme, which has a better cost advantage. However, when this scheme is actually used as the wearing detection function in different ears, a problem of probabilistic functional abnormality occurs.

A principle of the capacitive wearing detection scheme is utilizing the capacitive sensor to detect a capacitance change. When a human skin approaches or contacts the capacitive sensor, the capacitance value changes, and whether the earphone is worn on an ear is determined by detecting the change.

It can be known from the principle of the capacitive wearing detection scheme that the capacitance value of the Cap-sensor (capacitive sensor) is directly related to an area of the human ear skin that contacts a detection area of the sensor, that is, the larger the skin contact area is, the larger the capacitance value is. Therefore, there is a problem that ear contours, shapes, and wearing angles of different people (including differences in gender, age, obesity, and the like) are quite different, causing that the areas of the skin contacting the detection area of the Cap-sensor are also quite different when they wear the earphone.

When the earphone is worn on the ear, since there may be an obvious gap between the detection area and the skin, the capacitance value of the sensor may be significantly reduced, and there is a probability of functional abnormality of the wearing detection, including that the in-ear state cannot be detected or the out-of-ear state is automatically detected after the in-ear state.

In view of this, the scheme can solve the problem of the probabilistic functional abnormality of the wearing detection caused by the difference of the human ears during the actual use of the capacitive wearing detection scheme. In the scheme, the Cap-sensor is used as a main detection sensor, and two auxiliary detections are introduced simultaneously, including detecting and identifying the angle and direction of the earphone (e.g., the first pose information and the second pose information) using the G-Sensor (e.g., the acceleration transducer), and detecting and identifying a sealing situation of wearing the earphone on the human ear (e.g., the first sealing information and the second sealing information) using the infrasound sensor. By assisting in determining a use state of the earphone through two auxiliary detection sensors, and adding corresponding software determination logic, a problem of adaptability of the human ear may be solved.

A process in which the user wears the earphone is a time period in which the capacitance value of the Cap-sensor changes greatly, and after the wearing is stable, the capacitance value decreases or fluctuates. Since the technical scheme has the two auxiliary detections, the wearing detection function may be implemented only if the main detection Cap-sensor has a sufficient capacitance value when the earphone has just entered the ear. After the wearing is stable, even if the capacitance value of the Cap-sensor decreases or is even lower than the out-of-ear threshold, a wearing out-of-ear function is not falsely triggered.

### 1.1. Overall design block diagram:

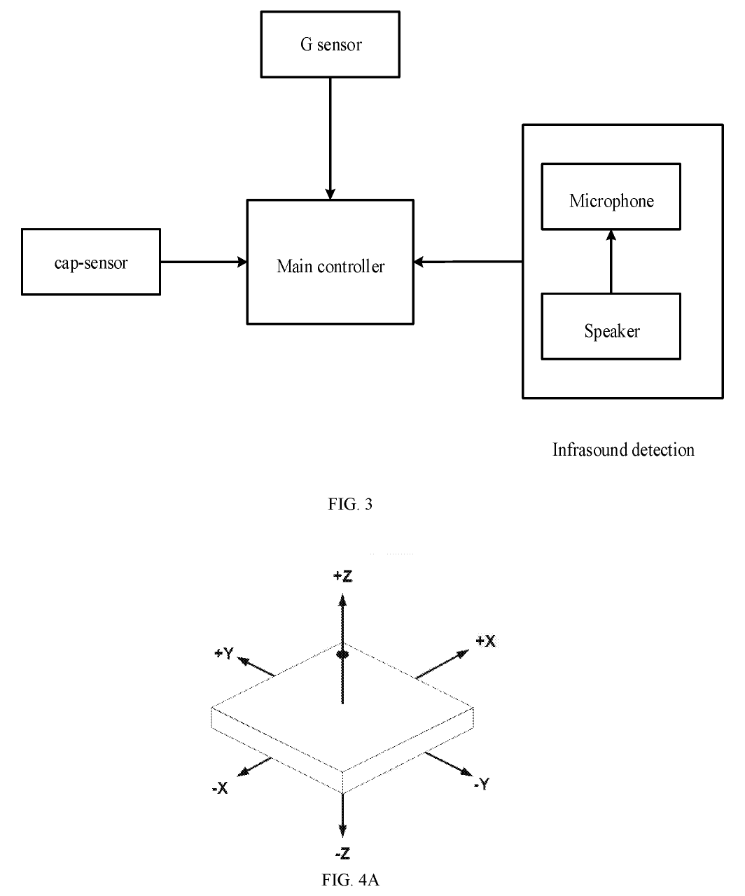

As shown in FIG. 3, the block diagram is a hardware system block diagram of the earphone, including a main controller, a Cap-sensor main detection unit (that is, the capacitive sensor), and two auxiliary detection units of a G SENSOR (that is, the acceleration transducer) and the infrasound sensor. Specifically, the infrasound sensor includes a microphone and a speaker (that is, a loudspeaker).

### 1.2. Function description of G Sensor:

### 1. Description of G SENSOR detection unit:

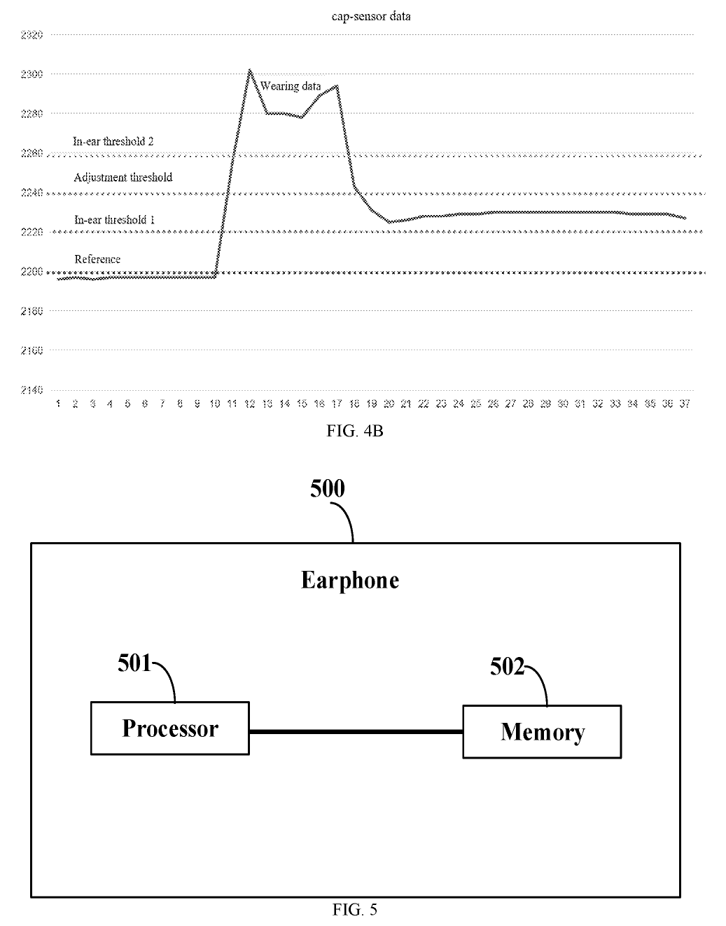

The G SENSOR may be an acceleration transducer and may be used for real-time detection of the tilt angle and the direction of the earphone. As shown in FIG. 4A, the sensor has data of three axes X, Y and Z, and may implement determination of a spatial angle and position. For example, angle and direction information of the earphone worn on the human ear (including the first pose information and the second pose information) may be read as an auxiliary determination condition for the wearing of the earphone.

### 2. Condition for G SENSOR determining wearing in ear:

As shown in FIG. 4B, it is data under each angle of front, back, left, and right of a human head when the earphone is worn on the human ear.

A data range of an angle the earphone is normally worn on the human head may be obtained from the drawings, and may be defined as: X-axis data range: Xmin to Xmax; where Xmin represents a preset minimum X-axis numerical value, and Xmax represents a preset maximum X-axis numerical value; Y-axis data range: Ymin to Ymax; where Ymin represents a preset minimum Y-axis numerical value, and Ymax represents a preset maximum Y-axis numerical value; Z-axis data range: Zmin to Zmax; where Zmin represents a preset minimum Z-axis numerical value, and Zmax represents a preset maximum Z-axis numerical value;

The data of the three axes of the G SENSOR need to be within the ranges simultaneously to meet an in-ear wearing condition.

Assuming that measured data of the G Sensor is Xdata, Ydata, and Zdata, the earphone wearing condition is met only when Xmin < Xdata < Xmax; Ymin < Ydata < Ymax; and Zmin < Zdata < Zmax are met. When not met, it is determined that the user is taking off the earphone.

### 1.3 Function description of Infrasound

### 1) Principle of infrasound auxiliarily determining wearing detection

In the earphone, from bottom to top, there are the speaker, the microphone, and a sound outlet in sequence. The infrasound is a sound signal with a frequency below 20Hz (Hertz), and a sound source in this frequency band cannot be heard by the human ear.

Description of specific implementation principle:

If the earphone is not worn on the human ear, the speaker emits an audio signal of 15Hz with a fixed amplitude at this time, and an amplitude of the audio signal of15Hz obtained by the microphone is X1;

If the earphone is worn on the human ear at this time, different from a scenario of not wearing, the sound outlet is in a relatively sealed space of an ear canal. When the speaker emits the audio signal of 15Hz with the same amplitude, due to sound field reflection in the space, the amplitude of the audio signal obtained by the microphone increases significantly, and it is assumed that the capacitance value at this time is X2;

Since there is an obvious difference between the values of X2 and X1, whether the earphone is worn on the human ear may be determined therefrom, serving as an auxiliary determination scheme for the wearing detection;

Since the speaker cannot emit other music signals when emitting the infrasound, the infrasound may only be enabled in a specific scenario, such as a moment when the user just wears the earphone on the ear.

### 2) Condition for determining wearing in ear by infrasound detection:

In the earphone, the speaker plays an infrasound signal lower than 20Hz. In two states of wearing or not wearing the earphone on the human ear, signal magnitudes received by the microphone have an obvious difference, and the received capacitance value increases significantly after wearing. Here, energy levels of the infrasound received by the microphone may be divided into levels for determining a wearing situation of the earphone.

The capacitance value is lower than an infrasound energy level 1, the received infrasound energy is low, and the state is a non-wearing state; the capacitance value is between the infrasound energy level 1 and an infrasound energy level 2, and the state is worn but partially leaking; the capacitance value is greater than the infrasound energy level 2, the received energy is relatively large, and the state is well worn and sealed.

### Description of implementation scheme

### 2.1 Scheme description of Cap-sensor threshold adjustment and in-ear logic

Based on the main detection scheme Cap-sensor and the auxiliary detection scheme, a matching degree situation (e.g., the matching degree result) of the earphone and the human ear is determined:

The Cap-sensor detection function has two preset in-ear thresholds, which are an in-ear threshold 1 (e.g., the second in-ear threshold) and an in-ear threshold 2 (e.g., the first in-ear threshold). Since the in-ear threshold 1 is relatively close to a reference value, there is a risk of false triggering (for example, a case with large temperature fluctuation). The earphone first defaults a Cap-sensor detection threshold to the in-ear threshold 2 with a relatively large value;

When there are n (several) continuous values greater than the in-ear threshold 2 within a time t during the wearing process of the earphone, and a value after stable wearing is greater than the third in-ear threshold, it is considered that the human ear matches the earphone well, and no threshold adjustment is needed;

When the value after stable wearing of the earphone is less than the third in-ear threshold and greater than the in-ear threshold 1, and both the infrasound detection and the G sensor detection meet the in-ear condition, it is considered that the earphone is still in the wearing state, but the matching degree between the human ear and the earphone is average, and the out-of-ear threshold needs to be adjusted to the in-ear threshold 1;

When there is no n continuous values greater than the in-ear threshold 2 during the wearing process of the earphone or the value is lower than the in-ear threshold 1 after the stable wearing, it is determined as a non-in-ear wearing state;

Reasons why the in-ear wearing needs two auxiliary detections to be met simultaneously: for a scenario where the value of the main detection wearing is relatively low, it is necessary to ensure 100% that the earphone is normally worn on the human ear before reducing the in-ear threshold. If only one auxiliary detection is enabled, some scenarios cannot be covered;

Scenario 1: The earphone is worn reversely on the human ear, in which case the G SENSOR detection does not meet the in-ear condition, and the infrasound detection meets the in-ear condition;

Scenario 2: A human hand holds the earphone and the angle is the wearing angle, in which case the G SENSOR detection meets the in-ear condition, and the infrasound detection does not meet the in-ear condition.

2.2 Processing logic of earphone wearing out-of-ear scenario: the main detection sensor, Cap-sensor, reads a raw data change situation in real time; and detecting whether there are n continuous values less than the out-of-ear threshold within the time t; 3) Obtaining the wearing matching degree during the in-ear wearing, and distinguishing between wearing well and wearing moderately; 4) In a well wearing in-ear scenario, an out-of-ear event may be output without enabling the auxiliary detection; 5) In a moderately wearing in-ear scenario, the auxiliary detection needs to be enabled; 6) First enabling the G SENSOR wearing auxiliary detection, and then enabling the infrasound wearing auxiliary detection. The earphone can be confirmed as not out of ear only when both the two auxiliary detections meet the in-ear condition;

Note: Since music cannot be played when the infrasound detection is enabled, the infrasound detection is enabled later, having relatively small impact on user experience.

5) After confirming the earphone as not out of ear, there is no need to read states of the main detection and the infrasound detection, and the G SENSOR detection is cyclically enabled;

6) If the G SENSOR detection does not meet the in-ear state, the out-of-ear event is output.

The ultrasonic wave is a signal greater than 20kHz. Since the ultrasonic wave has a high frequency and a short wavelength, and strong penetration ability during propagation, the reflected energy received by the microphone is small when the earphone is worn on the ear. In addition, limited by device performance, this is a speaker curve, the output amplitude of the speaker decreases rapidly after 15kHz.

It should be noted that, in addition to the foregoing content, this example may further include the technical features described in the above examples, so as to achieve the technical effect of the method for detecting a wearing state of an earphone described above, which refers to the above description for details and is not repeated here for brevity.

In the scheme, the capacitive wearing detection scheme adds two auxiliary detections of G SENSOR and the infrasound sensor. Through software processing logic of the main detection scheme and the two auxiliary detection schemes in cooperation, the defect in principle of the capacitive wearing detection scheme may be solved, so that functional abnormality does not occur when the scheme is actually used as the earphone wearing detection function in different ears. In addition, adding two auxiliary detection means of the G SENSOR and infrasound detections makes the function of the capacitive wearing detection scheme more reliable.

FIG. 5 illustrates a structural diagram of an earphone provided by an example of the present disclosure. The earphone 500 shown in FIG. 5 includes: at least one processor 501 and a memory 502. Components in the earphone 500 are coupled together.

It can be understood that the memory 502 in the example of the present disclosure may be a volatile memory or a nonvolatile memory, or may include both volatile and nonvolatile memories. The nonvolatile memory can be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), which is used as an external cache. By way of example, but not limitation, many forms of RAM are available, such as a static random access memory (SRAM), a dynamic random access memory (DRAM), a synchronous DRAM (SDRAM), a Double Data Rate SDRAM (DDRSDRAM), an enhanced SDRAM (ESDRAM), a Synch link DRAM (SLDRAM) and a Direct Rambus RAM (DRRAM). The memory 502 described herein is intended to include, but is not limited to, these and any other suitable types of memory.

In some examples, the memory 502 stores following elements, executable units or data structures, or subsets thereof, or extended sets thereof: an operating system and an application program.

The operating system includes various system programs, such as a framework layer, a core library layer, a driver layer, etc., which are used to realize various basic services and to handle hardware-based tasks. The application program includes various application programs, such as a Media Player and a Browser, which are used to realize various application services. A program for implementing the method of the example of the present disclosure may be included in the application program.

In this example, by calling programs or instructions stored in the memory 502, specifically, programs or instructions stored in the application program, the processor 501 is configured to perform steps of the method according to the examples, which for example include: determining that the earphone meets an in-ear condition based on a capacitance value of the capacitive sensor when the earphone is in an initial wearing stage; determining a wearing matching degree result of the earphone based on the capacitance value of the capacitive sensor when the earphone is in a stable wearing stage; obtaining first pose information of the earphone and first sealing information when the wearing matching degree result is mismatched, where the first pose information indicates a position and/or attitude of the earphone, and the first sealing information indicates a sealing state of an in-ear part of the earphone; and determining whether a current actual state of the earphone is an in-ear state based on the first pose information and the first sealing information.

The method disclosed in the examples of the present disclosure may be applied to the processor 501 or implemented by the processor 501. The processor 501 may be an integrated circuit chip with signal processing capability. In an implementation process, steps of the above method may be completed by an integrated logic circuit of hardware or an instruction in a form of software in the processor 501. The processor 501 may be general processors, Digital Signal Processors (DSPs), application specific integrated circuits (ASICs), Field Programmable Gate Arrays (FPGA) or other programmable logic devices, discrete gate or transistor logic devices, or discrete hardware components. The methods, steps and logic blocks disclosed in the present disclosure may be implemented or executed. The general processor may be a microprocessor, or the processor may be any conventional processor, etc. Steps of the method disclosed in the present disclosure may be directly embodied to be executed and completed by a hardware decoding processor, or to be executed and completed by a combination of hardware and software units in the decoding processor. Software units can be located in a random access memory, a flash memory, a read-only memory, a programmable read-only memory or an electrically erasable programmable memory, registers and other mature storage media in the art. The storage medium is located in the memory 502, and the processor 501 reads information in the memory 502 to complete steps of the above method in combination with its hardware.

It can be understood that the examples described herein may be implemented in hardware, software, firmware, middleware, microcode or a combination thereof. For hardware implementations, the processing unit may be implemented in one or more disclosure specific integrated circuits (ASICs), Digital Signal Processing (DSPs), DSP devices (DSPDs), Programmable Logic Devices (PLDs), Field-Programmable Gate Arrays (FPGAs), general processors, controllers, microcontrollers, microprocessors, other electronic units for performing above functions of the present disclosure, or a combination thereof.

For software implementations, techniques described herein may be realized by units that perform functions described herein. Software codes may be stored in the memory and executed by the processor. The memory may be implemented in the processor or external to the processor.

The electronic device according to this example may be the electronic device as shown in FIG. 5, and may perform all of steps of the method for detecting a wearing state of an earphone, so as to achieve the technical effect of the method for detecting a wearing state of an earphone described above, which refers to the above related description for details and is not repeated here for brevity.

An example of the present disclosure further provides a storage medium (e.g., non-transitory computer-readable storage medium) on which one or more programs are stored. The storage medium may include a volatile memory, such as a random access memory. The memory may also include a non-volatile memory, such as a read-only memory, a flash memory, a hard disk or a solid-state hard disk. The memory may also include a combination of above types of memories.

When the one or more programs in the storage medium are executed by one or more processors, the above method for detecting a wearing state of an earphone is implemented.

The above processors are configured to execute the program of detecting a wearing state of an earphone stored in the memory, so as to implement the steps of the method for detecting a wearing state of an earphone: determining that the earphone meets an in-ear condition based on a capacitance value of the capacitive sensor when the earphone is in an initial wearing stage; determining a wearing matching degree result of the earphone based on the capacitance value of the capacitive sensor when the earphone is in a stable wearing stage; obtaining first pose information of the earphone and first sealing information when the wearing matching degree result is mismatched, where the first pose information indicates a position and/or attitude of the earphone, and the first sealing information indicates a sealing state of an in-ear part of the earphone; and determining whether a current actual state of the earphone is an in-ear state based on the first pose information and the first sealing information.

In addition, the computer program product provided by the present disclosure may include computer-readable code. When the computer-readable code runs on a device, a processor in the device implements the steps of the method for detecting a wearing state of an earphone: determining that the earphone meets an in-ear condition based on a capacitance value of the capacitive sensor when the earphone is in an initial wearing stage; determining a wearing matching degree result of the earphone based on the capacitance value of the capacitive sensor when the earphone is in a stable wearing stage; obtaining first pose information of the earphone and first sealing information when the wearing matching degree result is mismatched, where the first pose information indicates a position and/or attitude of the earphone, and the first sealing information indicates a sealing state of an in-ear part of the earphone; and determining whether a current actual state of the earphone is an in-ear state based on the first pose information and the first sealing information.

Those skilled in the art can further realize that units and algorithm steps of each example described in combination with the examples disclosed herein can be implemented by electronic hardware, computer software or combination thereof. In order to clearly illustrate the interchangeability of hardware and software, the composition and steps of the examples have been described generally by function in the above description. Whether these functions are implemented by hardware or software depends on specific application and design constraints of the technical solution. Those of skilled in the art can use different methods to realize the described functions for each specific application, but the realization should not be considered beyond the scope of the present disclosure.

The steps of the methods or algorithms described in the examples disclosed herein may be implemented in hardware, a processor-executed software module, or a combination of both. The software module may be placed in random access memory (RAM), memory, read-only memory (ROM), electrically programmable ROM, electrically erasable programmable ROM, register, hard disk, removable magnetic disk, CD-ROM, or any other form of storage medium known in the art.

It should be understood that the terms used herein are only for the purpose of describing specific examples and are not intended to be limiting. Unless the context clearly indicates otherwise, the singular forms "a", "an" and "the" as used herein can also mean including plural forms. The terms “include", "including", “comprise" and "comprising" are inclusive and thus indicate the presence of features, steps, operations, elements and/or components described, but do not exclude the presence or addition of one or more other features, steps, operations, elements, components, and/or combinations thereof. The method steps, processes, and operations described herein are not interpreted as necessarily requiring them to be executed in the specific order described, unless the execution order is explicitly indicated. It should also be understood that additional or alternative steps may be used.

The above-described is only specific examples of the disclosure, which enables those skilled in the art to understand or realize the disclosure. Various modifications to these examples will be obvious to those skilled in the art, and general principles defined herein can be implemented in other examples without departing from the spirit or scope of this disclosure. Therefore, the disclosure will not be limited to the examples illustrated herein, but should conform to the widest scope consistent with the principles and novel features disclosed herein.

What is claimed is:

1. A method for detecting a wearing state of an earphone, comprising:
determining that the earphone meets an in-ear condition based on a capacitance value of a capacitive sensor in the earphone when the earphone is in an initial wearing stage;
determining a wearing matching degree result of the earphone based on the capacitance value of the capacitive sensor when the earphone is in a second wearing stage;
in response to the wearing matching degree result being mismatched, obtaining sealing information of the earphone, wherein the sealing information indicates a sealing state of an in-ear part of the earphone; and
determining a current state of the earphone based on the sealing information.

2. The method of claim 1, wherein the determining that the earphone meets the in-ear condition comprises:
based on detecting that each of a plurality of continuous capacitance values is greater than a first in-ear threshold, determining that the earphone meets the in-ear condition.

3. The method of claim 2, wherein the determining the wearing matching degree result of the earphone comprises:
based on detecting that the capacitance value is lower than or equal to a third in-ear threshold and greater than a second in-ear threshold, determining that the wearing matching degree result of the earphone is mismatched, wherein the third in-ear threshold is greater than the second in-ear threshold and lower than the first in-ear threshold.

4. The method of claim 1, wherein the determining the current state of the earphone comprises:
based on determining that the earphone is in a preset pose and that the in-ear part is in the sealing state, determining that the current state of the earphone is an in-ear state; and
based on determining that the earphone is not in the preset pose or that the in-ear part is in a leaking state, determining that the current state of the earphone is an out-of-ear state.

5. The method of claim 1, after determining the current state of the earphone, further comprising:
determining that the earphone meets an out-of-ear condition based on the capacitance value;
obtaining the wearing matching degree result of the earphone when the earphone is in the second wearing stage;
based on determining that the wearing matching degree result is mismatched, obtaining pose information of the earphone and second sealing information of the in-ear part, wherein the pose information indicates a pose of the earphone, and the second sealing information indicates the sealing state of the in-ear part; and
determining the current state of the earphone to be an out-of-ear state based on the pose information and the second sealing information.

6. The method of claim 5, wherein the determining that the earphone meets an out-of-ear condition based on the capacitance value comprises:
based on detecting that each of a second plurality of continuous capacitance values is less than an out-of-ear threshold, determining that the earphone meets the out-of-ear condition.

7. The method of claim 1, further comprising:
determining a pose of the earphone based on an acceleration transducer in the earphone, wherein the current state of the earphone is further determined based on the pose of the earphone.

8. The method of claim 7, further comprising
determining the sealing information based on an infrasound sensor in the earphone.

9. The method of claim 8, wherein:
a first start time of the infrasound sensor is later than a second start time of the acceleration transducer;
the first start time indicates a start time when the infrasound sensor receives a signal for determining the sealing information; and
the second start time indicates a start time when the acceleration transducer receives a signal for determining the pose.

10. The method of claim 7, wherein the pose of the earphone includes a tilt angle and direction of the earphone.

11. An earphone comprising:
one or more processors;
memory storing instructions that, when executed by the one or more processors, cause the earphone to:
determine that the earphone meets an in-ear condition based on a capacitance value of a capacitive sensor in the earphone when the earphone is in an initial wearing stage;
determine a wearing matching degree result of the earphone based on the capacitance value of the capacitive sensor when the earphone is in a second wearing stage;
in response to the wearing matching degree result being mismatched, obtain sealing information of the earphone, wherein the sealing information indicates a sealing state of an in-ear part of the earphone; and
determine a current state of the earphone based on the sealing information.

12. The earphone of claim 11, wherein the instructions, when executed by the one or more processors, cause the earphone to determine that the earphone meets the in-ear condition by causing:
based on detecting that each of a plurality of continuous capacitance values is greater than a first in-ear threshold, determining that the earphone meets the in-ear condition.

13. The earphone of claim 11, wherein the instructions, when executed by the one or more processors, cause the earphone to determine the current state of the earphone by causing:
based on determining that the earphone is in a preset pose and that the in-ear part is in the sealing state, determining that the current state of the earphone is an in-ear state; and
based on determining that the earphone is not in the preset pose or that the in-ear part is in a leaking state, determining that the current state of the earphone is an out-of-ear state.

14. The earphone of claim 11, wherein the instructions, when executed by the one or more processors, cause the earphone to, after determining the current state of the earphone:
determine that the earphone meets an out-of-ear condition based on the capacitance value;
obtain the wearing matching degree result of the earphone when the earphone is in the second wearing stage;
based on determining that the wearing matching degree result is mismatched, obtain pose information of the earphone and second sealing information of the in-ear part, wherein the pose information indicates a pose of the earphone, and the second sealing information indicates the sealing state of the in-ear part; and
determine the current state of the earphone to be an out-of-ear state based on the pose information and the second sealing information.

15. The earphone of claim 11, wherein the instructions, when executed by the one or more processors, cause the earphone to:
determine a pose of the earphone based on an acceleration transducer in the earphone; and
determine the current state of the earphone further determined based on the pose of the earphone.

16. The earphone of claim 11, wherein the instructions, when executed by the one or more processors, cause the earphone to:
determine the sealing information based on an infrasound sensor in the earphone.

17. The earphone of claim 15, wherein the pose of the earphone includes a tilt angle and direction of the earphone.

18. One or more non-transitory computer-readable media storing instructions, when executed, cause:
determining that an earphone meets an in-ear condition based on a capacitance value of a capacitive sensor in the earphone when the earphone is in an initial wearing stage;
determining a wearing matching degree result of the earphone based on the capacitance value of the capacitive sensor when the earphone is in a second wearing stage;
in response to the wearing matching degree result being mismatched, obtaining sealing information of the earphone, wherein the sealing information indicates a sealing state of an in-ear part of the earphone; and
determining a current state of the earphone based on the sealing information.

19. The one or more non-transitory computer-readable media of claim 18, wherein the instructions, when executed, cause the determining that the earphone meets the in-ear condition by causing:
based on detecting that each of a plurality of continuous capacitance values is greater than a first in-ear threshold, determining that the earphone meets the in-ear condition.

20. The one or more non-transitory computer-readable media of claim 18, wherein the instructions, when executed, cause the determining the current state of the earphone by causing:
based on determining that the earphone is in a preset pose and that the in-ear part is in the sealing state, determining that the current state of the earphone is an in-ear state; and
based on determining that the earphone is not in the preset pose or that the in-ear part is in a leaking state, determining that the current state of the earphone is an out-of-ear state.
